(19) United States
(12) Patent Application Publication
(10) Pub. No.: US 2014/0009710 A1
(43) Pub. Date: Jan. 9, 2014

(54) DISPLAY APPARATUS AND DRIVING METHOD

(71) Applicant: Sony Corporation, Tokyo (JP)

(72) Inventor: Yusuke Doi, Kanagawa (JP)

(21) Appl. No.: 13/927,358

(22) Filed: Jun. 26, 2013

(30) Foreign Application Priority Data
Jul. 5, 2012 (JP) 2012-151388

(51) Int. Cl. G02F 1/1362

(52) U.S. Cl. CPC G02F 1/136259
USPC 349/43

(57) ABSTRACT

A display apparatus includes a pixel cell. The pixel cell includes a pixel transistor configured to be electrically conducted by driving a gate line, a pixel, an auxiliary capacitance, and an anti-fuse element. The pixel includes a pixel electrode, an opposite electrode, and a liquid-crystal layer. The liquid-crystal layer is formed between the pixel electrode and the opposite electrode. The pixel cell is provided at each of intersection points between a plurality of gate lines and a plurality of signal lines. The pixel electrode, one end of the auxiliary capacitance, and one end of the anti-fuse element are connected to a drain of the pixel transistor in the pixel cell.

### BACKGROUND

The present disclosure relates to a so-called active matrix type display apparatus and a driving method therefor. In particular, the present disclosure relates to a technique of enhancing a manufacturing yield by transforming a bright spot defect into a dark spot.

In recent years, in a liquid-crystal display apparatus, a normally black mode is generally employed for a product the contrast of which is important. In the normally black mode, a black display is performed when no voltage is applied to a liquid crystal. When a voltage is applied, light transmission increases corresponding to an electric potential thereof.

In the normally black mode, when a pixel electrode is short-circuited at an electric potential other than an opposite-electrode electric potential, for example, a gate electric potential of a pixel transistor or an electric potential present near the pixel such as a ground electric potential, a problem of a bright spot defect is caused.

In a manufacturing process for the display apparatus, generation of such a bright spot defect becomes a problem because the yield is deteriorated.

For solving the problem of a bright spot defect, Japanese Patent Application Laid-open No. HEI 5-313167 (hereinafter, referred to as Patent Document 1) and Japanese Patent Application Laid-open No. HEI 8-15660 (hereinafter, referred to as Patent Document 2) disclose a method of irradiating a defective pixel as a target with a laser beam to break and remove the defective pixel for transforming a bright spot into a dark spot.

In general, as a pixel defect, a dark spot has lower spectral luminous efficiency than the bright spot. Therefore, the above-mentioned transformation of a bright spot into a dark spot can enhance the yield of product.

### SUMMARY

However, the traditional method as described above needs a laser irradiation apparatus in addition to a manufacturing apparatus for the display apparatus. Further, there is a fear that foreign matters and the like are generated due to tipping by the laser irradiation and other defects occur.

According to an embodiment of the present disclosure, a display apparatus is configured as follows.

That is, the display apparatus according to the embodiment of the present disclosure includes a pixel cell including a pixel transistor configured to be electrically conducted by driving a gate line, a pixel, an auxiliary capacitance, and an anti-fuse element, pixel including a pixel electrode, an opposite electrode, and a liquid-crystal layer, the liquid-crystal layer being formed between the pixel electrode and the opposite electrode, the pixel cell being provided at each of intersection points between a plurality of gate lines and a plurality of signal lines.

Further, the pixel electrode, one end of the auxiliary capacitance, and one end of the anti-fuse element are connected to a drain of the pixel transistor in the pixel cell.

Further, according to another embodiment of the present disclosure, there is provided a driving method for the display apparatus according to the embodiment of the present disclosure, the method being configured as follows.

That is, in the driving method according to another embodiment of the present disclosure, regarding the display apparatus according to the embodiment of the present disclosure, the anti-fuse element is electrically conducted by driving at least the gate line to which the pixel cell as a bright spot is connected.

With the display apparatus according to the embodiment of the present disclosure, the anti-fuse element is provided in parallel to the pixel. By electrically conducting the anti-fuse element by the driving method, the pixel electrode can be short-circuited at the same electric potential as an opposite-electrode electric potential. That is, instead of the pixel electrode being short-circuited at a gate electric potential of the pixel transistor, the pixel electrode can be short-circuited at the same electric potential as the opposite-electrode electric potential by electrical conduction of the anti-fuse element. In this manner, the pixel electrode can be short-circuited at the same electric potential as the opposite-electrode electric potential. Therefore, the pixel to become a bright spot can be transformed into a dark spot.

The dark spot has significantly low spectral luminous efficiency in comparison with the bright spot. Therefore, it is possible to achieve an enhancement in yield of product by the above-mentioned transformation of the bright spot into the dark spot.

The method of breaking the pixel by laser irradiation as in the traditional method of transforming a bright spot into a dark spot is not used. Therefore, without using an additional laser irradiation apparatus and causing other defects, it is possible to more efficiently transform a bright spot into a dark spot.

As mentioned above, according to the embodiments of the present disclosure, it is possible to more efficiently perform an enhancement in yield by transforming a bright spot into a dark spot without using an additional laser irradiation apparatus and causing other defects as in the traditional method.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a circuit diagram showing a configuration of a pixel cell of a display apparatus according to an embodiment;

FIG. 2 is a circuit diagram showing a configuration of a traditional pixel cell;

FIG. 3 is an explanation diagram relating to a normally black mode;

FIG. 4 is a view equivalently showing a circuit configuration of the pixel cell upon occurrence of a defect of a pixel transistor;

FIG. 5 is a view equivalently showing a circuit configuration of the pixel cell upon transformation of a bright spot into a dark spot by electrical conduction of an anti-fuse element;

FIG. 6 is a block diagram showing an entire configuration of a display panel;

FIG. 7 is a timing chart for explaining a typical driving method for the display panel;

FIG. 8 is a timing chart for explaining a driving method for electrically conducting the anti-fuse element;

FIG. 9 is a view showing a configuration example for detecting a bright spot pixel and electrically conducting the anti-fuse element of the bright spot pixel; and

FIG. 10 is a circuit diagram showing a configuration of the pixel cell in the display apparatus as a modified example.

### DETAILED DESCRIPTION OF EMBODIMENTS

Hereinafter, embodiments of the present disclosure will be described.

Note that descriptions will be made in the following order.

<1. Display Apparatus According to Embodiment>

[1-1. Configuration of Pixel Cell]

[1-2. Transformation of Bright Spot into Dark Spot in This Embodiment]

<2. Driving Method for Electrically Conducting Anti-Fuse Element>

<3. Modified Example>

### 1. Display Apparatus According to Embodiment

[1-1. Configuration of Pixel Cell]

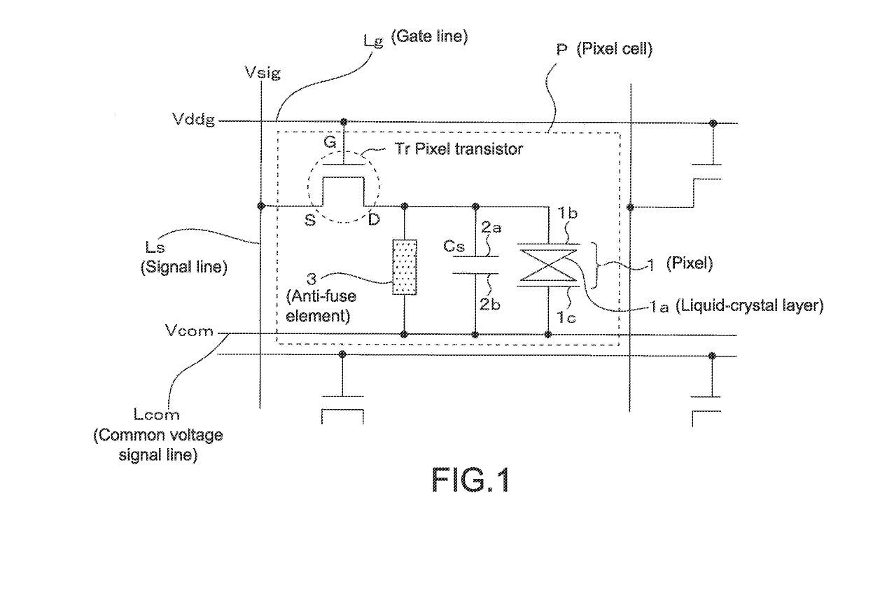

FIG. 1 is a circuit diagram showing a configuration of a pixel cell P of a display apparatus as an embodiment.

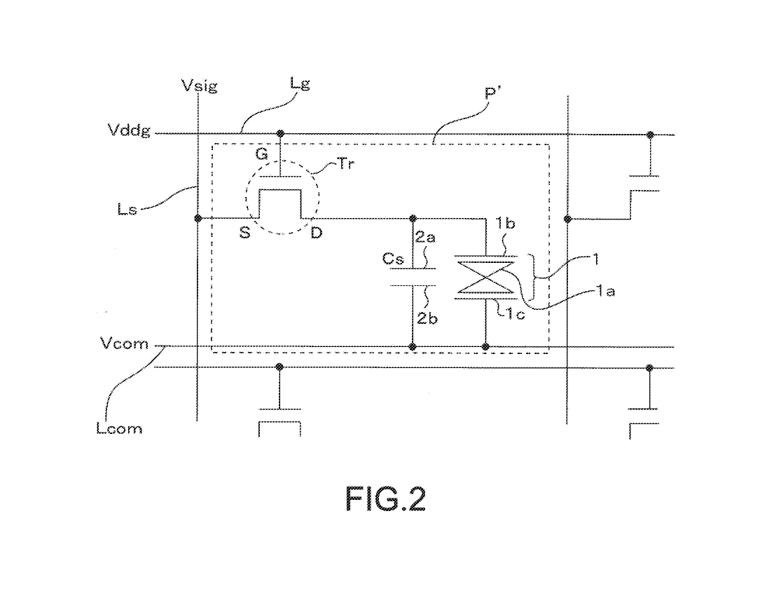

FIG. 2 shows a configuration of a pixel cell P′ of a traditional display apparatus as a comparison.

It is first assumed that the display apparatus according to this embodiment is a so-called active matrix type liquid-crystal display apparatus and a pixel cell P shown in FIG. 1 is one formed at each of intersection points between a plurality of gate lines Lg and a plurality of signal lines Ls. Although only a configuration of the pixel cell P provided at one intersection point is extracted and shown as a representative, a configuration of a pixel cell P provided at another intersection point is the same as that shown in FIG. 1.

Further, the display apparatus according to this embodiment is a display apparatus in a so-called normally black mode.

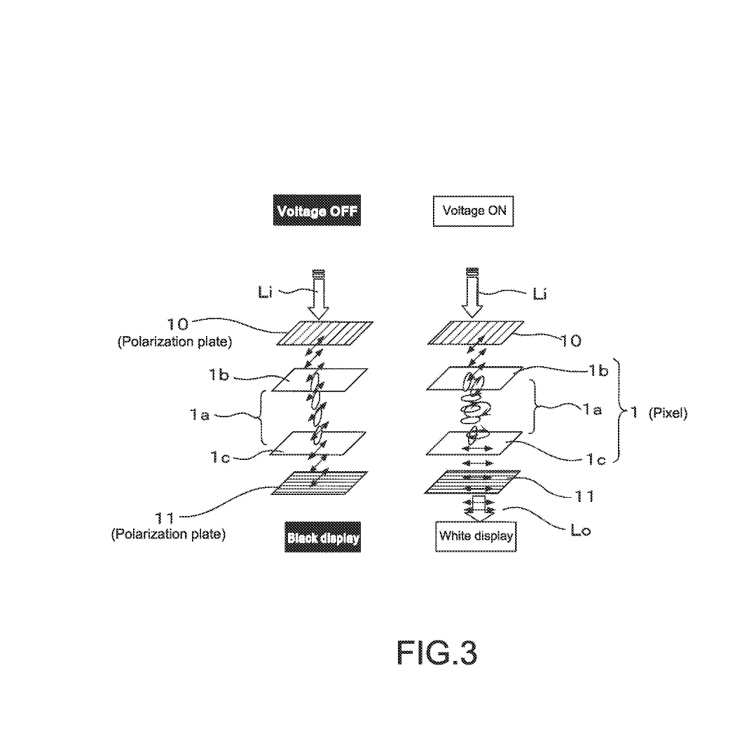

FIG. 3 is an explanation diagram relating to the normally black mode. Note that FIG. 3 schematically shows a pixel 1, polarization plates 10 and 11, incident light Li, a light polarization state (solid-line arrow), and a liquid-crystal orientation state in a liquid-crystal layer 1a. The pixel 1 includes a pixel electrode 1b, an opposite electrode 1c, and the liquid-crystal layer 1a. The liquid-crystal layer 1a is provided between the pixel electrode 1b and the opposite electrode 1c. The polarization plates 10 and 11 are arranged before and after the pixel 1. The incident light Li is inputted from a side of the polarization plate 10. The light passes through the polarization plate 10, the pixel 1, and the polarization plate 11 in the stated order. The liquid-crystal layer 1a depends on on/off of a voltage on the pixel 1.

As shown in FIG. 3, the normally black mode means that black display is performed when application of a voltage to the pixel 1 is off (the pixel electrode 1b and the opposite electrode 1c have the same electric potential), and light is transmitted when application of a voltage to the pixel 1 is on (the pixel electrode 1b and the opposite electrode 1c have different electric potentials).

Refer back to FIG. 1.

In FIG. 1, the pixel cell P includes the pixel 1, an auxiliary capacitance Cs, and a pixel transistor Tr.

The pixel 1 includes the pixel electrode 1b and the opposite electrode 1c. The opposite electrode 1c is connected to a common voltage signal line. An electric potential Vcom is applied to the opposite electrode 1c. The liquid-crystal layer 1a is provided between the pixel electrode 1b and the opposite electrode 1c.

In the pixel transistor Tr, a gate thereof (G in figure) is connected to the gate line Lg. A source (S in figure) is connected to the signal line Ls. In addition, the pixel electrode 1b of the pixel 1 and a first electrode 2a of an auxiliary capacitance 2 are connected to a drain (D in figure) of the pixel transistor Tr.

As shown in the figure, a second electrode 2b (electrode opposed to first electrode 2a) of the auxiliary capacitance 2 is connected to a common voltage signal line Lcom.

In such a pixel cell P, a gate voltage Vddg is applied to a gate of the pixel transistor Tr via the gate line Lg. The pixel transistor Tr is electrically conducted. In that state, a signal voltage Vsig is applied via the signal line Ls. Thus, writing of a signal with respect to the pixel 1 is performed.

The above-mentioned configuration up to this point is the same as the configuration in the traditional pixel cell P′ shown in FIG. 2.

The pixel cell P according to this embodiment is provided with an anti-fuse element 3.

Specifically, the anti-fuse element 3 is, at one end thereof, connected to a drain of the pixel transistor Tr. The anti-fuse element 3 is, at the other end thereof, connected to the common voltage signal line Lcom.

That is, the anti-fuse element 3 is connected to the drain of the pixel transistor Tr in parallel to the pixel 1 and the auxiliary capacitance Cs.

[1-2. Transformation of Bright Spot into Dark Spot in This Embodiment]

In the related art, in the pixel cell P′, due to a defect and the like of a gate oxide film of the pixel transistor Tr, an error in which the gate of the pixel transistor Tr and the pixel electrode 1b are short-circuited may occur.

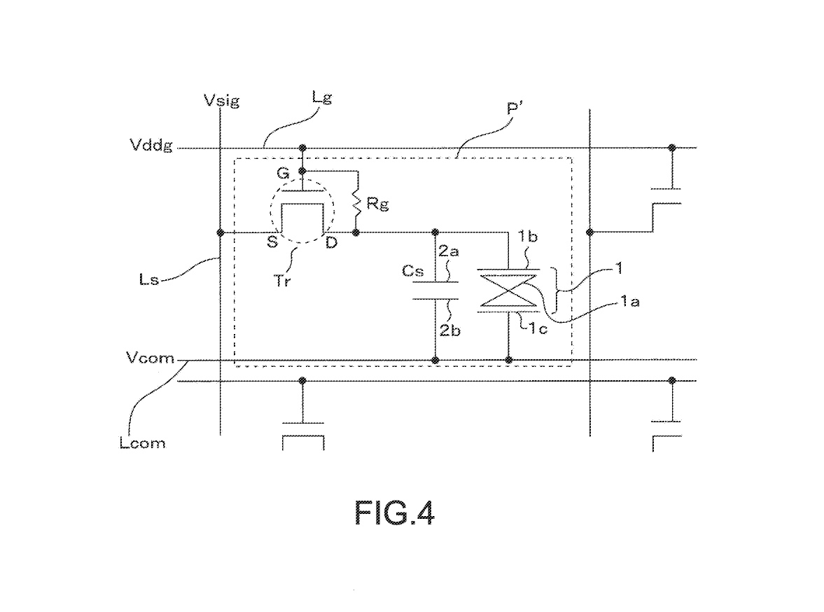

FIG. 4 equivalently shows a circuit configuration of the pixel cell P′ upon occurrence of a defect of the pixel transistor Tr. In the case where the normally black mode is employed, corresponding to the short-circuit of the gate of the pixel transistor Tr and the pixel electrode 1b as described above, the pixel electrode 1b is pulled up to a gate potential Vddg via a resistance Rg in the figure.

As a result, between the pixel electrode 1b and the opposite electrode 1c, a direct-current voltage corresponding to the amount of “Vddg-Vcom” is constantly applied. Therefore, the pixel 1 in this case becomes a bright spot.

Therefore, in this embodiment, as shown in FIG. 1, the pixel cell P is provided with the anti-fuse element 3. By electrically conducting the anti-fuse element 3 in the pixel cell P as the bright spot, the pixel cell P is transformed from the bright spot into a dark spot to achieve an enhancement in yield.

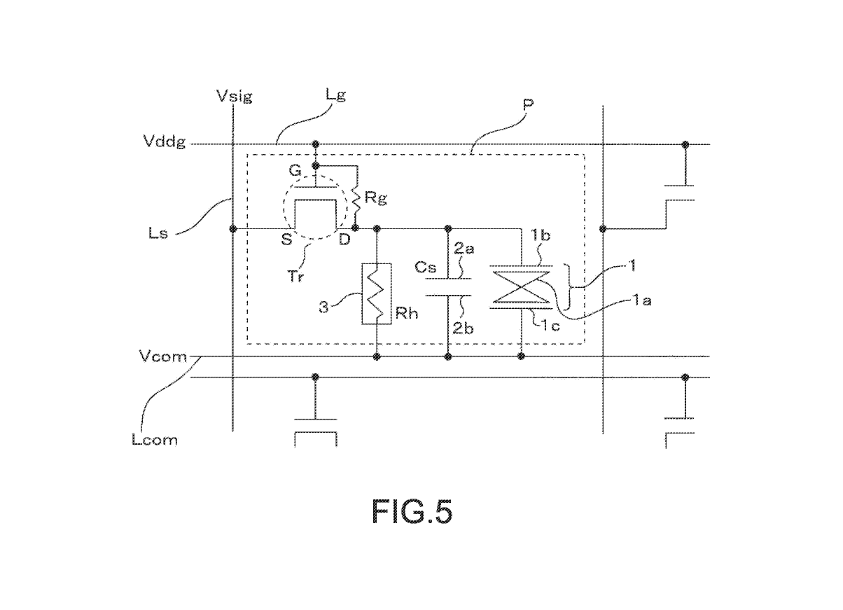

FIG. 5 equivalently shows a circuit configuration of the pixel cell P in the case where the anti-fuse element 3 is electrically conducted.

As shown in the figure, the anti-fuse element 3 after electrical conduction can be considered as a resistance Rh having a necessary resistance value.

In this embodiment, the anti-fuse element 3 having a resistance value of the resistance Rh that is smaller than the resistance value of the resistance Rg between the gate of the pixel transistor Tr and the pixel electrode 1b (the resistance value between the gate and the drain of the pixel transistor Tr when the gate of the pixel transistor Tr and the pixel electrode 1b are short-circuited due to a defect).

With this, upon occurrence of a defect of the pixel transistor Tr, the pixel electrode 1b can be short-circuited at the same electric potential as the electric potential of the opposite electrode 1c. That is, the pixel electrode 1b can be substantially pulled down to the electric potential Vcom of the common voltage signal line Lcom.

As a result, a difference in the electric potential from the opposite electrode 1c can be prevented from being generated. The pixel 1 can be constantly in a black display state (dark spot). That is, the pixel 1 to become the bright spot can be transformed into the dark spot.

In this manner, the pixel 1 to become the bright spot can be changed to the dark spot having low spectral luminous efficiency. Therefore, it is possible to achieve an enhancement in yield of product.

The method of breaking a pixel by laser irradiation as in the traditional method of transforming a bright spot into a dark spot (Patent Documents 1 and 2) described above is not used. Therefore, without using an additional laser irradiation apparatus and causing other defects, it is possible to more efficiently achieve an enhancement in yield by the transformation of the bright spot into the dark spot.

### 2. Driving Method for Electrically conducting Anti-Fuse Element

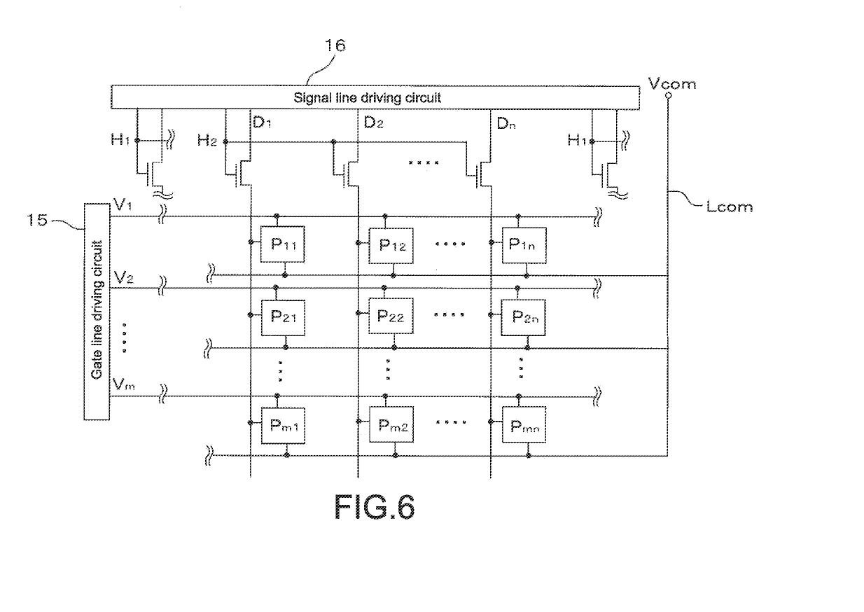

Next, a specific driving method for electrically conducting the anti-fuse element 3 will be described with reference to FIGS. 6 to 8.

FIG. 6 is a block diagram showing an entire configuration of a display panel of the display apparatus according to this embodiment.

In this embodiment, the following example will be first described. In the example, the signal lines Ls arranged in a horizontal direction are grouped for every n-number of signal lines Ls. For every n-number of signal lines Ls, simultaneous writing is performed (so-called n-phase drive). Specifically, it relates to a drive of pixel cells P arranged on a single gate line Lg.

Sequential writing for each pixel cell P is not performed. Simultaneous writing for every n-number of pixel cells P is performed.

In this case, the number of blocks to be subjected to simultaneous writing is set to 1. Therefore, this display panel is provided with an n*l-number of signal lines Ls.

H₁, H₂, . . . Hₗ in the figure become synchronous signals for performing simultaneous writing on the respective blocks in the n-phase drive. Specifically, those are signals for turning on/off the n-number of signal lines belonging to each block.

In FIG. 6, the gate lines Lg of the display panel are set to an m-number of gate lines Lg. Here, the m-number of gate lines Lg are denoted by V₁, V₂, . . . Vₘ.

Further, the n-number of signal lines Ls are denoted by D₁, D₂, . . . Dₙ.

In the figure, only the n-number (a total of n*m) of pixel cells P belonging to a second simultaneous writing block (block on which writing is performed according to a synchronous signal H₂) on the gate lines Lg are extracted and shown. A total of an m*n-number of pixel cells P are denoted by reference symbols P₁₁ to Pₘₙ. Here, regarding the reference symbols of the pixel cell P, a numeric character of an inferior letter on a left-hand side indicates the gate line Lg to which the pixel cell P is connected, and a numeric character of an inferior letter on a right-hand side indicates the signal line Ls to which the pixel cell P is connected.

In this display panel, a gate line driving circuit 15 in the figure drives the m-number of gate lines Lg. Further, a signal line driving circuit 16 drives the n* 1-number of signal lines Ls.

Specifically, the gate line driving circuit 15 subsequently drives the m-number of gate lines Lg one by one in one frame period.

The signal line driving circuit 16 turns on/off the signal lines for every n-number of signal lines using the synchronous signals H₁ to H₁. In one horizontal line period (1H period), a total of an n*l-number of signal lines are subsequently driven for every n-number of signal lines.

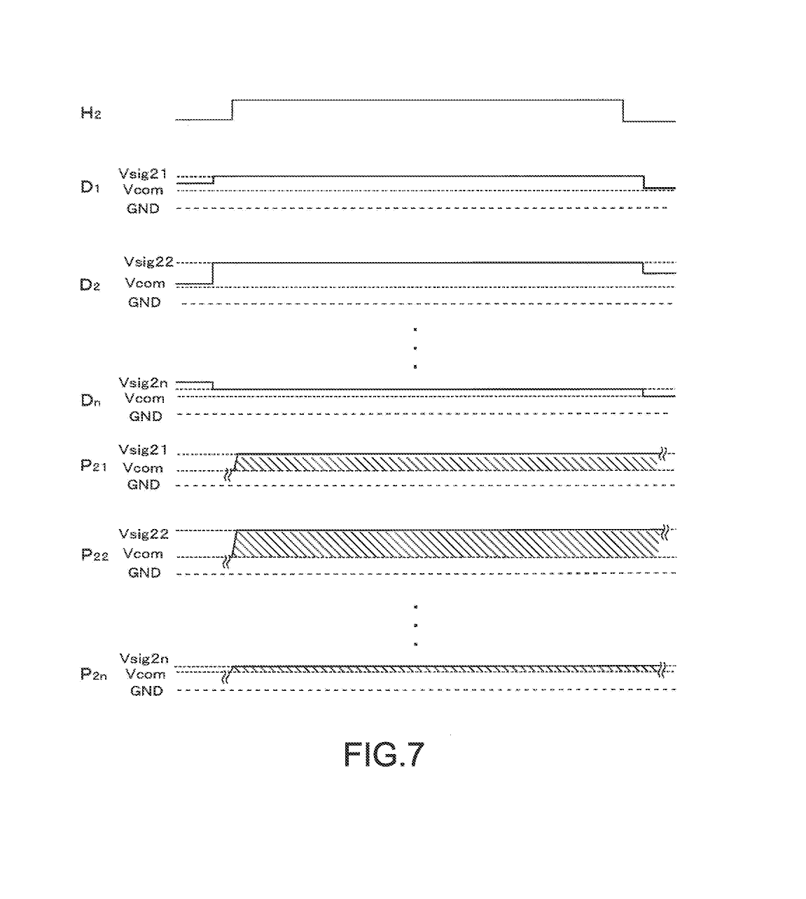

FIG. 7 is a timing chart for explaining a typical driving method for the display panel.

In FIG. 7, a driving waveform of the second simultaneous writing block on a second gate line D₂ shown in FIG. 6 is extracted and shown. Specifically, the synchronous signal H₂, a driving signal of each of signal lines D₁, D₂, and Dₙ, and an application voltage of the pixel electrode 1b in each of the pixel cells Pₙ, P₂₂, and P₂ₙ are shown.

In normal driving, the signal voltages Vsig (electric potentials Vsig21, Vsig22, Vsig2n in figure) corresponding to display data are applied to the signal lines D_{I}, D₂, and Dₙ. At this time, a difference between a voltage Vsig and the electric potential Vcom applied to the opposite electrode 1c becomes an effective voltage applied to the pixel 1 and the anti-fuse element 3 (oblique portions in figure).

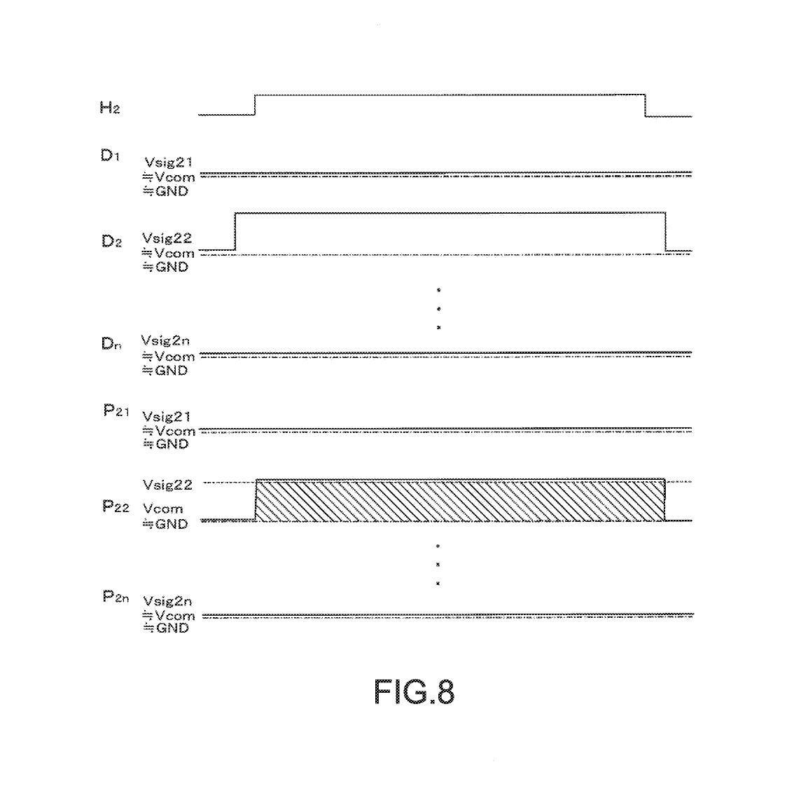

FIG. 8 is a timing chart for explaining a driving method for electrically conducting the anti-fuse element.

Here, a case where a bright spot defect occurs in a pixel cell P₂₂ and the anti-fuse element 3 in the pixel cell P₂₂ is electrically conducted is exemplified.

FIG. 8 shows, as in FIG. 7, the synchronous signal H₂, a driving signal of each of the signal lines D₁, D₂, and Dₙ, and an application voltage of the pixel electrode 1b in each of the pixel cells P₂₁, P₂₂, and P₂ₙ.

When the anti-fuse element 3 is electrically conducted, in a horizontal line period in which the gate line Lg (in this case, the gate line V₂) to which the pixel cell P (in this case, the pixel cell P₂₂) as a target is connected is selected, a voltage having an electric potential higher than an electrical breakdown voltage of the anti-fuse element 3 is applied to the anti-fuse element 3 by driving only the signal line Ls (in this case, the signal line D₂) to which the pixel cell P as the target is connected.

Specifically, in this example, as shown in the figure, the electric potential Vcom in the common voltage signal line Lcom is set to a GND (or electric potential as low as possible). Other than the pixel cell P electrically conducting the anti-fuse element 3, the signal line voltage Vsig is also set to the same electric potential as the electric potential Vcom. Only the signal line voltage Vsig of the pixel cell P electrically conducting the anti-fuse element 3 is set to an electric potential equal to or higher than the electrical breakdown voltage of the anti-fuse element 3.

With this, only the anti-fuse element 3 in the pixel cell P as the target can be selectively electrically conducted.

Note that, in FIG. 8, an oblique portion of the pixel cell P₂₂ corresponds to an effective voltage (voltage*time) applied to the anti-fuse element 3.

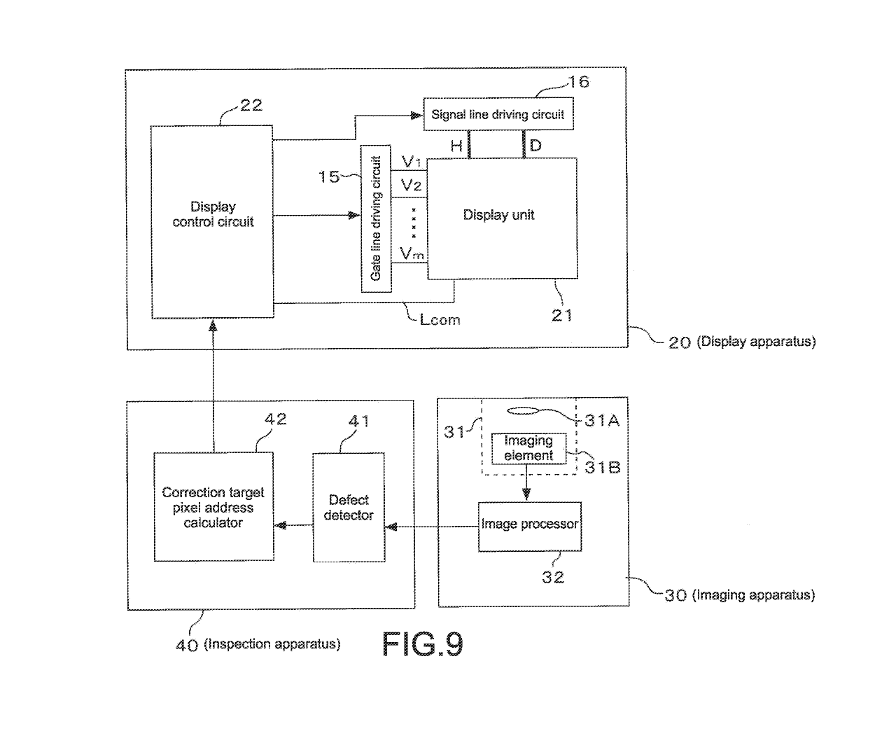

FIG. 9 is a view showing a configuration example for detecting a bright spot pixel and electrically conducting the anti-fuse element 3 of the bright spot pixel.

First, in FIG. 9, a display apparatus 20 indicates the display apparatus including the display panel described above with reference to FIG. 6. As shown in the figure, the display apparatus 20 includes at least a display unit 21, the gate line driving circuit 15, the signal line driving circuit 16, and a display control circuit 22. Here, the display unit 21 refers to a portion obtained by excluding the gate line driving circuit 15 and the signal line driving circuit 16 from the display panel shown in FIG. 6. In the figure, a line shown by a thick line H between the signal line driving circuit 16 and the display unit 21 generally indicates synchronous signal lines H₁, H₂, . . . Hₗ shown in FIG. 6. Lines shown by thick lines D generally indicate an n*l-number of signal lines D described in FIG. 6.

The display control circuit 22 instructs the gate line driving circuit 15 to drive an m-number of gate lines V₁ to Vₘ at a predetermined timing. Further, the display control circuit 22 instructs the signal line driving circuit 16 to perform an output control of the synchronous signals H₁ to H₁ and a driving control of the signal lines D for every n-number of signal lines D. Further, the display control circuit 22 can adjust the electric potential Vcom provided to the display unit 21 through the common voltage signal line Lcom.

In this case, an imaging apparatus 30 and an inspection apparatus 40 are used for detecting the bright spot pixel.

As shown in the figure, the imaging apparatus 30 includes an imaging unit 31 and an image processor 32. The imaging unit 31 includes an imaging lens 31A and an imaging element 31B. The image processor 32 obtains a capture image signal by processing a detection signal of the imaging element 31B.

The imaging apparatus 30 captures a display image of the display unit 21. A capture image signal obtained as a result is provided to the inspection apparatus 40.

The inspection apparatus 40 includes a defect detector 41 and a correction target pixel address calculator 42.

According to the capture image signal provided from the imaging apparatus 30, the defect detector 41 detects a position of the bright spot in that capture image. Then, the defect detector 41 provides position information thereof to the correction target pixel address calculator 42.

Based on the position information provided by the defect detector 41, the correction target pixel address calculator 42 calculates a pixel address of a defective pixel (bright spot pixel) on the display unit 21. Then, the correction target pixel address calculator 42 provides information on the calculated pixel address to the display control circuit 22 in the display apparatus 20.

The display control circuit 22 controls the gate line driving circuit 15 and the signal line driving circuit 16 and adjust the electric potential Vcom such that the anti-fuse element 3 in the pixel cell P specified by the provided information on the pixel address is electrically conducted. Note that the driving method for electrically conducting the anti-fuse element 3 in a specific pixel cell P is as described above with reference to FIG. 8. Here, a duplicated description is omitted.

Note that, if the bright spot is absent, for example, information on the absence only needs to be displayed on a display unit (not shown) of the inspection apparatus 40 and presented to an inspector or the like.

If the pixel electrode 1b is short-circuited with the gate line Lg due to a defect of the pixel transistor Tr in the pixel cell P to become the bright spot, it is considered that the gate cannot be opened even by driving the gate line Lg.

Considering such a situation, it is desirable to set the electrical breakdown voltage of the anti-fuse element 3 to be lower than the gate potential Vddg.

Under such setting of the electrical breakdown voltage of the anti-fuse element 3, as in the above-mentioned method, a method of lowering the electric potential Vcom to the same electric potential as the GND is employed. With this, by applying the gate voltage Vddg to the gate line Lg to which a pixel cell P as a target is connected, it is possible to electrically conduct the anti-fuse element 3 in the pixel cell P. That is, even if application of the gate voltage Vddg does not open the gate, the anti-fuse element 3 as the target can be electrically conducted.

Note that, in this case, only by applying the gate voltage Vddg to the gate line Lg to which the pixel cell P as the target (that is, the pixel cell P being the bright spot) is connected, only the anti-fuse element 3 in the pixel cell P as the target can be electrically conducted. However, at this time, whether or not to drive the signal line Ls is arbitrarily selected.

If the driving of the signal line Ls is omitted, the driving method for electrically conducting the anti-fuse element 3 can be further simplified.

Hereinabove, it is assumed that the method of lowering the electric potential Vcom to the same electric potential as the GND is employed. However, if that method is not employed, a voltage having the electric potential higher than the electrical breakdown voltage of the anti-fuse element 3 only needs to be applied to the gate line Lg connected to the pixel cell P as a target.

### 3. Modified Example

Although embodiments according to the present disclosure have been described above, the present disclosure should not be limited to the above-mentioned specific examples.

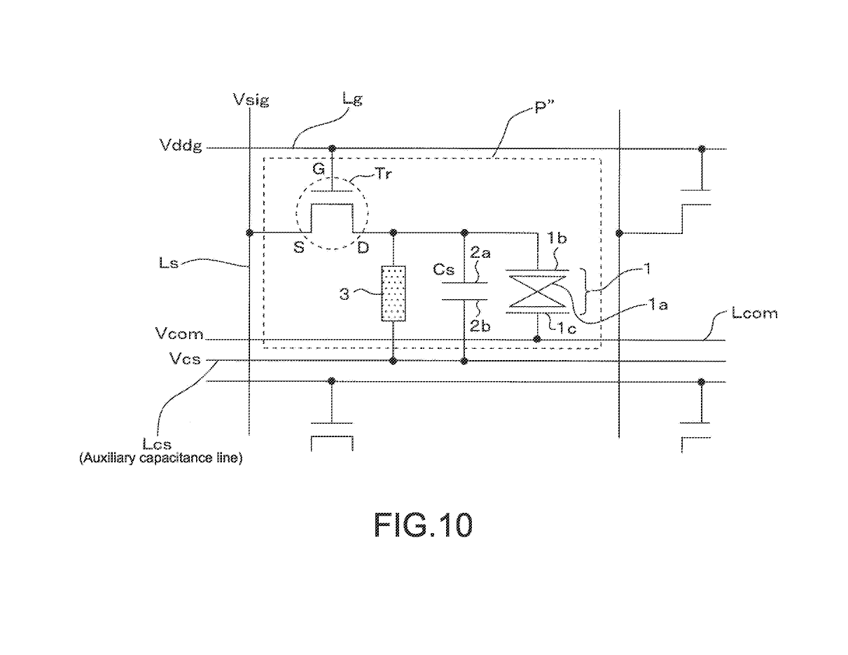

For example, in the above description, it is assumed that the configuration in which the second electrode 2b of the auxiliary capacitance 2 is connected to the common voltage signal line Lcom together with the opposite electrode 1c of the pixel 1 is employed. Therefore, also the anti-fuse element 3 is connected to the common voltage signal line Lcom. However, as shown in FIG. 10, the following configuration may be possible. In the configuration, the second electrode 2b of the auxiliary capacitance 2 is connected to an auxiliary capacitance wiring Lcs provided separately from the common voltage signal line Lcom (e.g., see Japanese Patent Application Laid-open No. 2007-52290 as follows).

If the second electrode 2b of the auxiliary capacitance 2 is connected to the auxiliary capacitance wiring Lcs in this manner, as shown in FIG. 10, also the anti-fuse element 3 can be connected to the auxiliary capacitance wiring Lcs (referred to as pixel cell P″). Specifically, in this pixel cell P″, one end of the anti-fuse element 3 is connected to the drain of the pixel transistor Tr and the other end is connected to the auxiliary capacitance wiring Lcs.

Here, although not shown in the figure, the auxiliary capacitance wiring Lcs is short-circuited at the electric potential Vcom of the common voltage signal line Lcom outside the display panel, or connected to another power supply that generates the same electric potential as the electric potential Vcom. That is, in this manner, the electric potential Vcs of the auxiliary capacitance wiring Lcs and the electric potential Vcom of the common voltage signal line Lcom have almost the same electric potential.

Therefore, also in the case where the configuration shown in FIG. 10 is employed, the pixel electrode 1b is short-circuited at the same electric potential as the electric potential Vcom by electrical conduction of the anti-fuse element 3. That is, also with the configuration as the modified example shown in FIG. 10, by electrical conduction of the anti-fuse element 3, the bright spot can be transformed into the dark spot as with the above-mentioned configuration shown in FIG. 1.

It should be noted that the present disclosure may also take the following configurations.

(1) A display apparatus, including

a pixel cell including
a pixel transistor configured to be electrically conducted by driving a gate line,
a pixel including a pixel electrode, an opposite electrode, and a liquid-crystal layer,
an auxiliary capacitance, and

an anti-fuse element, the liquid-crystal layer being formed between the pixel electrode and the opposite electrode, the pixel cell being provided at each of intersection points between a plurality of gate lines and a plurality of signal lines, the pixel electrode, one end of the auxiliary capacitance, and one end of the anti-fuse element being connected to a drain of the pixel transistor in the pixel cell.

(2) The display apparatus according to Item (1), in which
the anti-fuse element is configured to have a resistance value after electrical conduction that is lower than a resistance value between a gate and the drain of the pixel transistor when the gate line and the pixel electrode are short-circuited.
   (3) The display apparatus according to Item (2), in which the anti-fuse element is configured to have an electrical breakdown voltage lower than a gate voltage.
   (4) The display apparatus according to any one of Items (1) to (3), in which

the anti-fuse element has the other end connected to a common voltage signal line.

(5) The display apparatus according to any one of Items (1) to (3), in which

the anti-fuse element has the other end connected to an auxiliary capacitance wiring.

(6) A driving method for a display apparatus including a pixel cell including
a pixel transistor configured to be electrically conducted by driving a gate line,
a pixel including a pixel electrode, an opposite electrode, and a liquid-crystal layer,
an auxiliary capacitance, and
an anti-fuse element, the liquid-crystal layer being formed between the pixel electrode and the opposite electrode, the pixel cell being provided at each of intersection points between a plurality of gate lines and a plurality of signal lines, the pixel electrode, one end of the auxiliary capacitance, and one end of the anti-fuse element being connected to a drain of the pixel transistor in the pixel cell, the driving method including

driving at least the gate line, to which the pixel cell as a bright spot is connected, to electrically conduct the anti-fuse element.

(7) The driving method according to Item (6), further including

lowering an electric potential of the other end of the anti-fuse element before a voltage for electrically conducting the anti-fuse element is applied.

(8) The driving method according to Item (6) or (7), further including

driving the gate line and the signal line, to which the pixel cell as the bright spot is connected, to electrically conduct the anti-fuse element.

(9) The driving method according to any one of Items (6) to (8), further including

applying a voltage having an electric potential higher than an electrical breakdown voltage of the anti-fuse element to the gate line to which the pixel cell as a bright spot is connected.

(10) The driving method according to any one of Items (6) to (9), further including

applying a voltage having an electric potential higher than an electrical breakdown voltage of the anti-fuse element to the signal line to which the pixel cell as the bright spot is connected.

The present disclosure contains subject matter related to that disclosed in Japanese Priority Patent Application JP 2012-151388 filed in the Japan Patent Office on Jul. 5, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus, comprising
a pixel cell including
a pixel transistor configured to be electrically conducted by driving a gate line,
a pixel including a pixel electrode, an opposite electrode, and a liquid-crystal layer,
an auxiliary capacitance, and
an anti-fuse element, the liquid-crystal layer being formed between the pixel electrode and the opposite electrode, the pixel cell being provided at each of intersection points between a plurality of gate lines and a plurality of signal lines, the pixel electrode, one end of the auxiliary capacitance, and one end of the anti-fuse element being connected to a drain of the pixel transistor in the pixel cell.

2. The display apparatus according to claim 1, wherein
the anti-fuse element is configured to have a resistance value after electrical conduction that is lower than a resistance value between a gate and the drain of the pixel transistor when the gate line and the pixel electrode are short-circuited.

3. The display apparatus according to claim 2, wherein
the anti-fuse element is configured to have an electrical breakdown voltage lower than a gate voltage.

4. The display apparatus according to claim 1, wherein
the anti-fuse element has the other end connected to a common voltage signal line.

5. The display apparatus according to claim 1, wherein
the anti-fuse element has the other end connected to an auxiliary capacitance wiring.

6. A driving method for a display apparatus including a pixel cell including
a pixel transistor configured to be electrically conducted by driving a gate line,
a pixel including a pixel electrode, an
opposite electrode, and a liquid-crystal layer,
an auxiliary capacitance, and
an anti-fuse element, the liquid-crystal layer being formed between the pixel electrode and the opposite electrode, the pixel cell being provided at each of intersection points between a plurality of gate lines and a plurality of signal lines, the pixel electrode, one end of the auxiliary capacitance, and one end of the anti-fuse element being connected to a drain of the pixel transistor in the pixel cell, the driving method comprising
driving at least the gate line, to which the pixel cell as a bright spot is connected, to electrically conduct the anti-fuse element.

7. The driving method according to claim 6, further comprising
lowering an electric potential of the other end of the anti-fuse element before a voltage for electrically conducting the anti-fuse element is applied.

8. The driving method according to claim 6, further comprising
driving the gate line and the signal line, to which the pixel cell as the bright spot is connected, to electrically conduct the anti-fuse element.

9. The driving method according to claim 6, further comprising
applying a voltage having an electric potential higher than an electrical breakdown voltage of the anti-fuse element to the gate line to which the pixel cell as a bright spot is connected.

10. The driving method according to claim 8, further comprising
applying a voltage having an electric potential higher than an electrical breakdown voltage of the anti-fuse element to the signal line to which the pixel cell as the bright spot is connected.
